(19) United States
(12) Patent Application Publication
(10) Pub. No.: US 2023/0056985 A1
(43) Pub. Date: Feb. 23, 2023

(54) MICROBIAL EFFICIENCY-MATRIX STABILIZATION (MEMS) ECOSYSTEM MODEL AND METHODS

(71) Applicant: Colorado State University Research Foundation, Fort Collins, CO (US)

(72) Inventors: M. Francesca Cotrufo, Fort Collins, CO (US); Yao Zhang, Fort Collins, CO (US); Andrew Robertson, Fort Collins, CO (US); Jocelyn Lavallee, Fort Collins, CO (US); Keith H. Paustian, Fort Collins, CO (US); Stephen Ogle, Fort Collins, CO (US)

(21) Appl. No.: 17/405,289

(22) Filed: Aug. 18, 2021

(51) Int. Cl. G06F 30/20

(52) U.S. Cl. CPC G06F 30/20; G06F 2111/10

(57) ABSTRACT

A microbial efficiency-matrix stabilization (MEMS) 2.0 ecosystem model, with detailed pools and fluxes for the litter and soil components, represents carbon (C) and nitrogen (N) fluxes among atmosphere, plants, and soil, in multiple soil layers down to a user-defined depth. Inputs and recycling of N cause feedbacks to net primary productivity (NPP), which is allocated aboveground (ANPP) or belowground (BNPP) and at different depths, depending on vegetation and soil traits.

### STATEMENT OF GOVERNMENT SUPPORT

This invention was made with government support under 1743237 awarded by the National Science Foundation and DE-AR0000826 awarded by the U.S. Department of Energy. The government has certain rights in the invention.

### FIELD

The disclosure generally relates to microbial efficiency-matrix stabilization (MEMS) 2.0 ecosystem model and methods for determining and providing information around the pools of carbon (C) and nitrogen (N) in the soil, and C and N fluxes among soil, plants and the atmosphere.

### BACKGROUND

Ecosystem models provide valuable information around the pools and fluxes of C and N in soils and the atmosphere. Currently, many large global corporations are beginning to issue C credits based upon changes in agricultural practices. Agriculture is responsible for ⅓ of greenhouse gas (GHG) emissions globally and is seen as one of the most important natural climate solutions for reducing GHG emissions and sequestering carbon dioxide (CO₂). The potential value of these credits in the continental United States was estimated in 2017 at over $8 billion annually. The global market is significantly larger with an estimated annual value in the tens of billions of dollars. Ecosystem models are vital to this developing market, as they may be used to transform current and past field level data into information and estimates of future GHG emissions.

More particularly, one of the biggest challenges facing humanity is the need to halt the rise in atmospheric CO₂ concentrations, which requires a combined set of actions including management of terrestrial ecosystems to not only protect existing C stocks but to also increase net sequestration to actively remove CO₂ from the atmosphere. Such management strategies can only be reliably identified and implemented when guided by decision support tools and ecosystem models that can accurately predict C and N dynamics between plants, microbes, and soils, and their responses to environmental and management drivers using current scientific understanding. While these models should ideally be verifiable using measurements of their constituent pools and fluxes, the soil components of most historical ecosystem models were built around conceptual, rather than physically defined, pools. However, recent paradigm shifts in understanding of soil organic matter (SOM) formation and persistence have led to these belowground components of ecosystem models being redesigned. Ensuring that the soil pools and fluxes are measurable is particularly important if these models are to be used for estimating tradable C credits or outcome-based C sequestration incentives. These models must also simulate the entire soil profile, to account for C stocks and dynamics in deep (e.g., >30 cm) soil layers. Additionally, soil C storage requires N, and ecosystem C and N cycling are tightly linked, thus these models need to represent both C and N pools and fluxes.

Ultimately, these contemporary models that represent observed mechanisms of C and N dynamics will go beyond supporting management decisions, serving also as tools for scientific enquiry, enabling testing of new hypotheses and identification of knowledge gaps. While many models currently exist and are used for these purposes, none fully addresses all the needs. As a result, terrestrial C storage remains the largest source of uncertainty in future C cycle projections. Despite its critical role in global biogeochemical cycling, soil organic C is not well constrained in Earth System Models, highlighting the need for improved simulation of plant-microbial-soil C feedbacks.

Few ecosystem biogeochemical models have made measurable SOM pools a focal point, despite their importance for guiding model development and judging model performance. The microbial efficiency-matrix stabilization (MEMS) 1.0 model uses measured SOM fraction data for model calibration and verification, while other models continue to calibrate and validate them against total soil C. Many conventional SOM models do not model measurable SOM pools, and therefore attempts to validate their size have required abstraction based on measurable fractions. Instead, these models partition total SOM into discrete pools based on turnover times but differ in their approaches to simplify the complex mechanisms that govern SOM dynamics. Consequently, simulations of SOM pools and resulting total soil C stocks can vary greatly between models, sometimes predicting contrasting responses to the same driving inputs and environmental change.

Carbon dynamics and stock distribution between particulate OM (POM) and mineral-associated OM (MAOM) are linked to N. Moving beyond C only models to coupled C and N dynamics enables representation of mechanistic feedbacks, such as N limitation of litter decomposition and microbial C use efficiency (CUE). Additionally, this provides constraints on C and N flows according to well-known stoichiometric relationships. Many conventional models that include both C and N calculate N fluxes based on donor pool sizes and are constrained by the C:N ratios of receiving pools, with little or no representation of the microbial processes that control N dynamics. While this method is relatively simple, it fails to capture plant-microbial feedbacks that regulate N flows. For example, microbiota may alter exoenzyme production or mine SOM to access N to meet their needs, and plants may increase exudate production to stimulate these processes. Failing to represent N dynamics resulting from plant-microbial feedbacks may lead to inaccuracies in model predictions. Only a few emerging models have begun to represent these processes in greater detail, but most ecosystem models continue to use more simplified, microbial-implicit structures to simulate N dynamics.

Physicochemical and biological properties differ markedly between subsoils (e.g., >30 cm deep) and topsoils. Subsoils hold more than half of the total soil C, and SOM formation and stabilization processes differ from topsoils because key properties including soil texture and primary inputs to SOM, i.e., plant inputs versus vertical transport of dissolved organic matter (DOM), vary with soil depth. Most commonly, subsoil is modelled as an extension of topsoil with very limited if any validation, largely because of a paucity of subsoil data.

Incorporating emerging understanding of soil biogeochemical processes into models has the potential to improve model performance and increase their utility for hypothesis testing and predictions. Microbial processing of plant inputs is a key process by which SOM is formed, and mechanistically links SOM pools and plant litter quality, microbial CUE and C:N stoichiometry. For example, labile, water-soluble litter components are more likely to be processed by microbes with relatively high efficiency, forming proportionally more MAOM than structural litter components. This has been termed the in vivo pathway, but MAOM may also form directly from plant inputs by an ex vivo pathway that bypasses microbial processing. The relative importance of these pathways is thought to vary greatly between the rhizosphere and the bulk soil, with ex vivo MAOM production playing a larger role in the bulk soil, where the density of microbial cells is lower and DOM has less chance of being intercepted prior to mineral association. Inputs to SOM also differ between the rhizosphere and bulk soil, with aboveground plant inputs only contributing appreciably to SOM in the bulk soil due to its spatial separation from roots and their exudates, which are the predominant inputs to SOM formation in the rhizosphere. No conventional soil biogeochemical models represent all of these recent advances simultaneously.

It is with respect to these and other considerations that the various aspects and embodiments of the present disclosure are presented.

### SUMMARY

Provided and described herein is an ecosystem model, referred to as microbial efficiency-matrix stabilization (MEMS) 2.0, which builds on MEMS 1.0 to form a complete ecosystem model including N cycling, soil vertical water flows, DOM transport, plant growth, root input, and soil temperature dynamics. MEMS 2.0 represents distinct plant inputs and microbial processes in the litter layer and rhizosphere, and DOM, POM and MAOM dynamics in the bulk soil to a user-defined depth above the bedrock.

In an implementation, a system comprises: a plurality of inputs; and a microbial efficiency-matrix stabilization (MEMS) 2.0 ecosystem model configured to receive the plurality of inputs and generate information around the pools and fluxes of C and N in the soil, plant and the atmosphere; and a plurality of outputs comprising the generated information.

In an implementation, a method comprises: receiving a plurality of inputs at a microbial efficiency-matrix stabilization (MEMS) 2.0 ecosystem model, wherein the inputs comprise weather, soil properties, plant characteristics, and management practices; creating a soil profile and dividing the soil profile into continuous soil horizons in a model input file, with user-defined depths for each horizon; running a plurality of simulations with submodels using the MEMS 2.0 ecosystem model with the inputs and divided soil profile; producing outputs from the simulations with submodels, on a daily time step or a sub-daily time step; and providing the outputs to a display device or a storage device.

In an implementation, a one-dimension ecosystem model includes nitrogen (N) cycling, soil vertical water flows, dissolved organic matter (DOM) transport, plant growth, root input, and soil temperature dynamics, and wherein the ecosystem model represents distinct plant inputs and microbial processes in the litter layer and rhizosphere, and DOM, particulate organic matter (POM) and mineral-associated organic matter (MAOM) dynamics in the bulk soil to a user-defined depth above the bedrock.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an implementation of a MEMS 2.0 ecosystem model, showing detailed pools and fluxes for the litter and soil components;

FIG. 2 is an illustration of an implementation of a MEMS 2.0 ecosystem model with an object-oriented structure;

FIGS. 3A, 3B, and 3C illustrate a list of equations that may be used in an implementation of a MEMS 2.0 ecosystem model;

FIGS. 4A and 4B illustrate a list of variables used in equations of FIGS. 3A, 3B, and 3C;

FIGS. 5A, 5B, and 5C illustrate a list of parameters used in a plant growth submodel of an implementation of the MEMS 2.0 ecosystem model;

FIG. 6 is an operational flow of an implementation of a method for use with a MEMS 2.0 ecosystem model; and

FIG. 7 shows an exemplary computing environment in which example embodiments and aspects may be implemented.

### DETAILED DESCRIPTION

This description provides examples not intended to limit the scope of the appended claims. The description is not to be taken in a limiting sense but is made merely for the purpose of illustrating the general principles of the invention, since the scope of the invention is best defined by the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

Various inventive features are described herein that can each be used independently of one another or in combination with other features.

For decades, predominant soil biogeochemical models have used conceptual SOM pools and only simulated them to a shallow depth in soil.

More particularly, the MEMS 1.0 ecosystem model is a soil C model with physically defined pools that was developed in accordance with recent advances in SOM dynamics including the MEMS hypothesis and interactions between litter chemistry and MAOM saturation behavior. Provided and described herein is MEMS 2.0, which is an ecosystem model that builds on the MEMS 1.0 ecosystem model to form a complete ecosystem model including N cycling, soil vertical water flows, DOM transport, plant growth, root input, and soil temperature dynamics. MEMS 2.0 represents distinct plant inputs and microbial processes in the litter layer and rhizosphere, and DOM, POM and MAOM dynamics in the bulk soil to a user-defined depth above the bedrock.

MEMS 2.0, disclosed herein, is a full ecosystem model with modules simulating plant growth with aboveground and belowground inputs, soil water, and temperature by layer, decomposition of plant inputs and SOM, and mineralization and immobilization of N. The model simulates two commonly measured SOM pools—POM and MAOM.

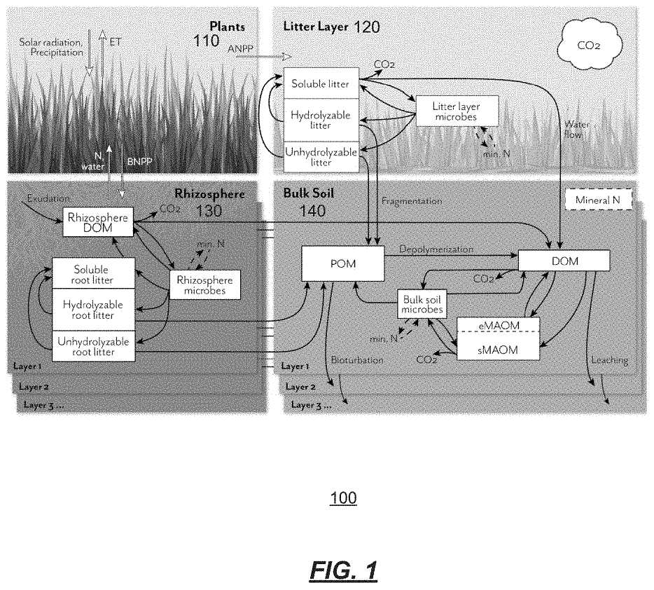

FIG. 1 shows a one-dimension ecosystem model 100, MEMS 2.0, which uses data from plants 110 to simulate litter layer 120, rhizosphere 130, and bulk soil 140 C, N, water, and temperature, as well as plant growth.

The ecosystem model 100 simulates a surface litter layer 120 which interacts with the first soil layer. In each soil layer, the space is conceptually divided into rhizosphere 130 and bulk soil 140, though there is no explicit spatial division due to the one-dimensional structure. Each simulated pool, including plant organs and soil organic pools, have both C and N components.

Plant C and N litter inputs (simulated in the plant growth submodel) are allocated to three different measurable detritus pools that differ in their solubility and chemical structure. Root exudates contribute to the rhizosphere DOM pool. These plant input pools lose mass through leaching, microbial catabolism/anabolism and fragmentation, with different rates depending on the pool C:N chemistry, temperature sensitivity, and mineral N and water demand/availability. Microbial and plant debris contribute to three physically defined and measurable SOM pools, according to current understanding (e.g., the dual-pathway model of SOM formation, in-vivo versus ex-vivo microbial processing, and point-of-entry): soil DOM, POM and MAOM. The MAOM consists of exchangeable and stable component pools (eMAOM and sMAOM, respectively). Microbial pools immobilize and mineralize N, which feeds back to plant production and soil biogeochemical processes. Multiple soil layers are represented by the same belowground model structure, with DOM and mineral N moving through the soil profile and roots contributing fresh inputs at depth.

The data from the plants 110 may include solar radiation and precipitation, for example. Aboveground net primary productivity (ANPP) may be provided to the litter layer 120 simulation, and belowground net primary productivity (BNPP), at different depths, may be provided to the rhizosphere 130 simulation. The litter layer 120 simulation and the rhizosphere 130 simulation may provide data to the bulk soil 140 simulation.

The litter layer 120 may simulate information such as soluble litter, hydrolyzable litter, unhydrolyzable litter, and litter layer microbes, along with CO₂, water flow, and mineral N.

The rhizosphere 130 simulates information such as exudation, rhizosphere DOM, CO₂ production, mineral N, rhizosphere microbes, soluble root litter, hydrolyzable root litter, and unhydrolyzable root litter, in various soil layers.

The bulk soil 140 may simulate fragmentation, depolymerization, POM, DOM, CO₂ production, mineral N, bulk soil microbes, exchangeable and stable MAOM components (eMAOM and sMAOM, respectively), and leaching, in various soil layers.

In an implementation, the MEMS 2.0 model is a process-based ecosystem model written in Java. The implementation represents C and N fluxes among atmosphere, plants and soil, in multiple soil layers. More particularly, in an implementation, the MEMS 2.0 ecosystem model is coded in Java with an object-oriented structure. In an implementation, it is a process-based deterministic ecosystem model with main submodels of SOM, plant growth, soil water, soil temperature, soil solutes, and management events. The main inputs are daily weather (e.g., maximum temperature, minimum temperature, and precipitation; solar radiation is optional), soil properties, plant characteristics, and management practices. A one-dimension soil profile is divided into continuous soil horizons in the model input file, with user-defined depths for each horizon. The ecosystem model 100 produces outputs on a daily time step. The soil water, soil temperature, plant and microbial nitrogen uptake, and bioturbation processes may be run on a sub-daily time step (hours) for higher prediction accuracy.

Thus, the MEMS 2.0 ecosystem model 100 represents an understanding of plant-microbial-soil C and N dynamics, using biophysically defined and measurable pools and fluxes. MEMS 2.0 includes dynamic microbial C use efficiency, point of entry, saturation, and in vivo/ex vivo pathway. In an implementation, the model represents C and N fluxes among atmosphere, plants, and soil, in multiple soil layers down to a user-defined depth. Inputs and recycling of N cause feedbacks to net primary productivity (NPP), which is allocated aboveground (ANPP) or belowground (BNPP) and at different depths, depending on vegetation and soil traits.

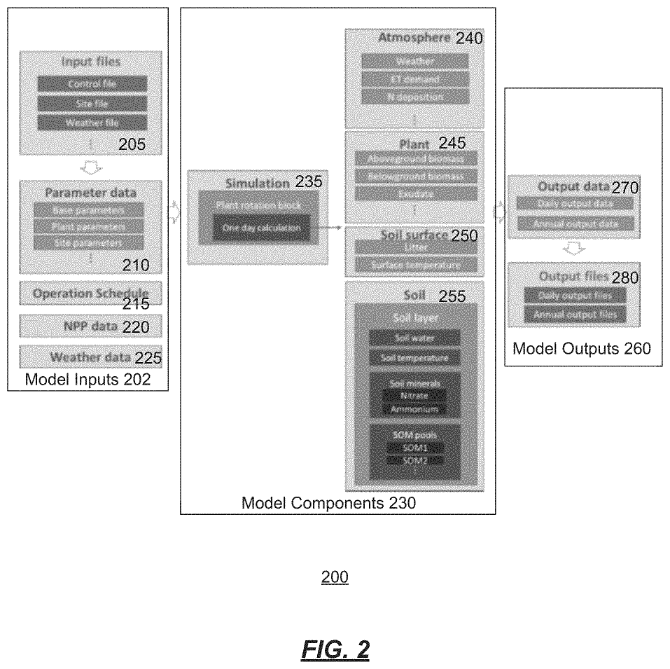

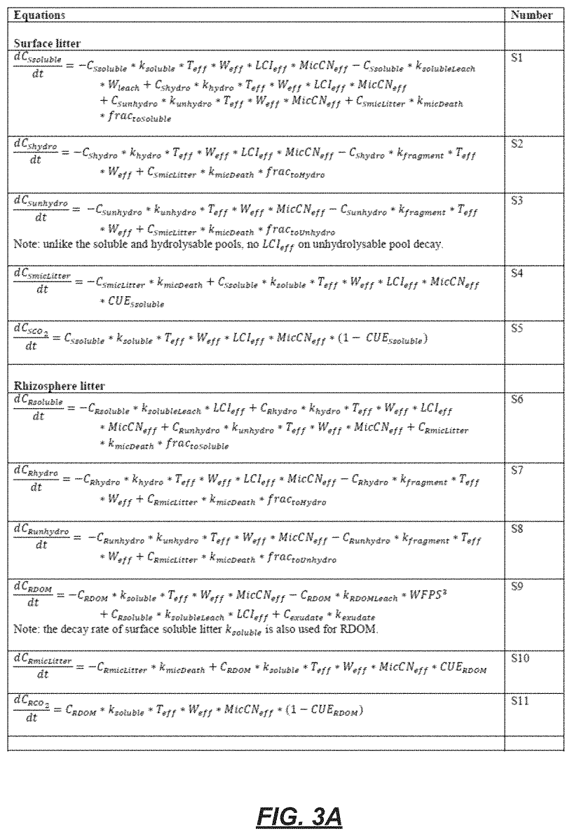

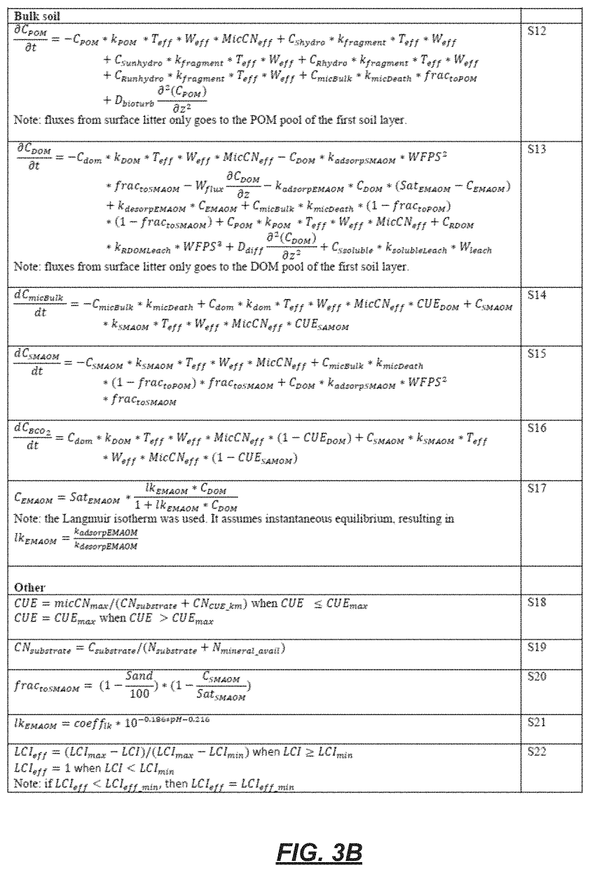

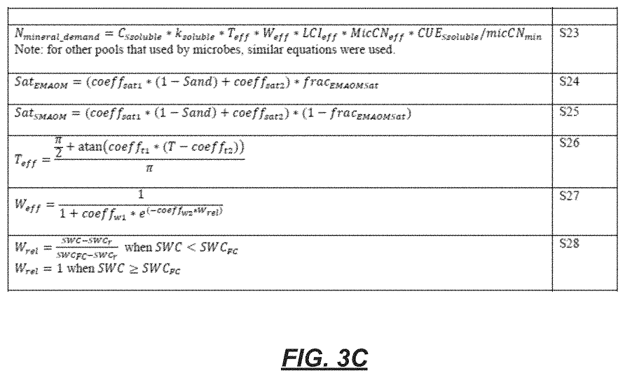

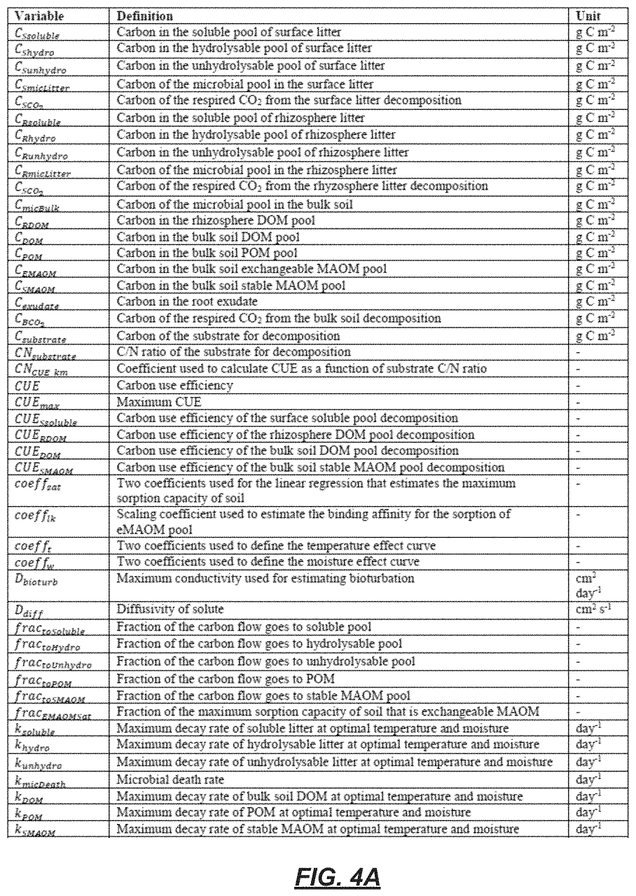

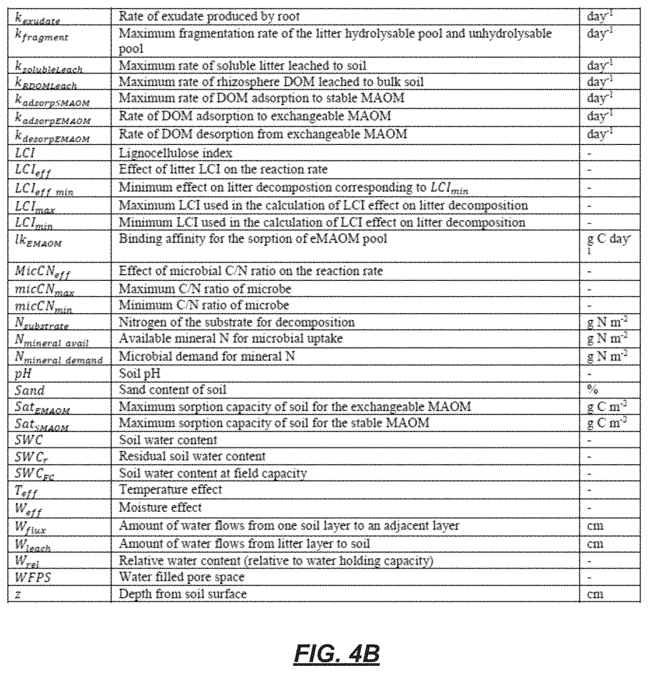

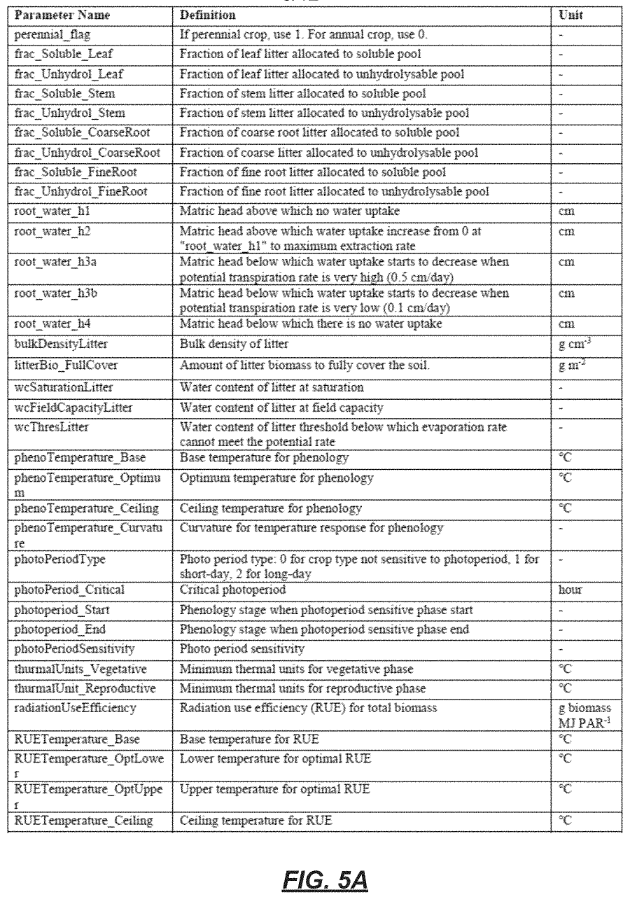

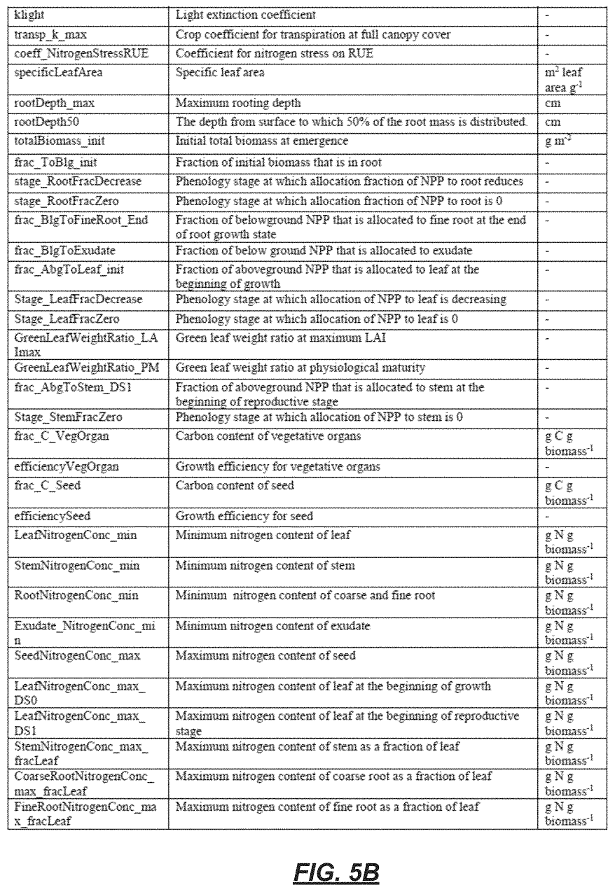

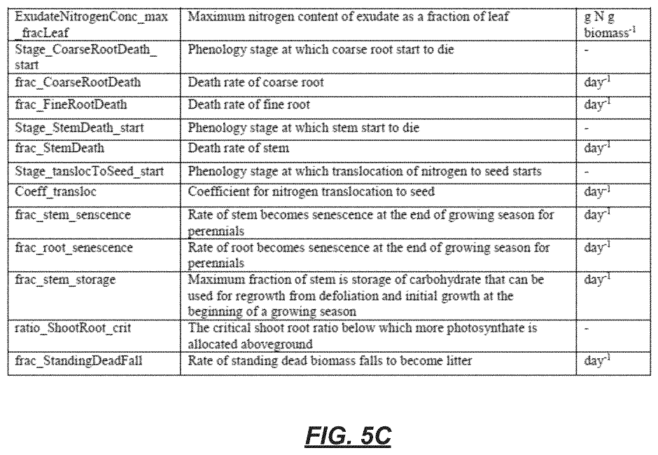

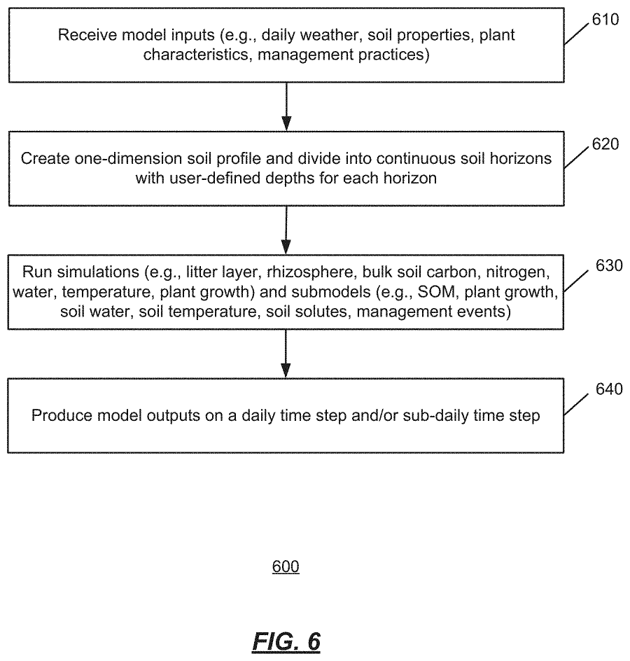

In an implementation, MEMS 2.0 is coded in Java with an object-oriented structure 200, as illustrated in FIG. 2. FIGS. 3A, 3B, and 3C illustrate a list of equations in an implementation of the MEMS 2.0 ecosystem model. FIGS. 4A and 4B illustrate a list of variables used in equations of FIGS. 3A, 3B, and 3C. FIGS. 5A, 5B, and 5C illustrate a list of parameters used in the plant growth submodel of an implementation of the MEMS 2.0 ecosystem model. FIG. 6 is an operational flow of an implementation of a method 600 for use with a MEMS 2.0 ecosystem model.

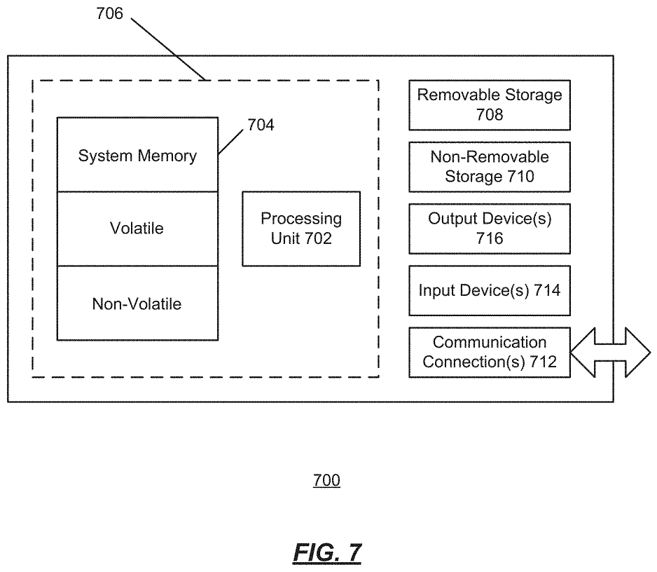

The structure 200 of FIG. 2 may be implemented on and/or across one or more computing devices and shows model inputs 202, model components 230, and model outputs 260. The model inputs 202 may be provided to the model components 230 using any known techniques, such as from a user computing device, a smartphone, one or more sensors or other computing devices, etc., depending on the implementation. The model components 230 may provide the model outputs 260 to a computing device, to storage, to a display, etc., depending on the implementation. A cloud database may be used. One or more computing devices and/or entities may be in communication with one another through one or more networks. Each network may be a variety of network types including a wireless local area network, the public switched telephone network (PSTN), a cellular telephone network, and a packet switched network (e.g., the Internet). There is no limit to the number of cloud databases, computing devices, smartphones, and/or other computing devices that may be supported. The cloud database, the model components 230 which may be implemented on at least one computing device, and other computing devices, may be implemented using a variety of computing devices such as smartphones, desktop computers, laptop computers, tablets, etc. Other types of computing devices may be supported. A suitable computing device is illustrated in FIG. 7 as the computing device 700.

The model inputs 202 comprise input files 205, parameter data 210, an operation schedule 215, NPP data 220, and weather data 225. The input files 205 comprises, for example, a control file, a site file, a weather file, etc. The parameter data 210 comprises, for example, base parameters, plant parameters, site parameters, etc.

At 610, the model inputs 202 are provided or otherwise received or obtained by the model components 230. As described further herein, inputs may include, for example, daily weather, soil properties, plant characteristics, management practices, etc., depending on the implementation.

At 620, a one-dimension soil profile is created and divided into continuous soil horizons in the model input file, with user-defined depths for each horizon. While executing a model simulation, the user-defined soil horizons are further divided into thinner layers to effectively solve partial differential equations.

At 630, simulations are run in accordance with submodels. In an implementation, the model components 230 run one or more simulations 235 using the inputs 202. Each simulation 235 may comprise plant rotation block with a one-day calculation. For example in an implementation, the simulation 235 may use submodels with algorithms directed to atmosphere 240, plant 245, soil surface 250, and soil 255. These submodels are not intended to be limiting any fewer or additional submodels may be used depending on the implementation. The atmosphere 240 submodel may comprise, for example, weather, evapotranspiration (ET) demand, N deposition, etc. The plant 245 submodel may comprise, for example, aboveground biomass, belowground biomass, exudate, etc. The soil surface 250 submodel may comprise, for example, litter, surface temperature, etc. The soil 255 submodel may comprise, for example, soil layer, soil water, soil temperature, soil minerals, nitrate, ammonium, SOM pools, etc.

At 640, outputs are produced on a daily time step and/or a daily time step. In an implementation, the model outputs 260 are provided from the model components 230 as output data 270. The output data 270 may be displayed, provided to one or more users and/or computing devices, stored in memory, etc., depending on the implementation. In an implementation, the output data 270 is recorded in output files 280 for storage, for example.

With respect to litter decomposition, MEMS 1.0 incorporated a Litter Decomposition and Leaching (LIDEL) model. In an implementation of MEMS 2.0, this submodel is modified to explicitly represent the depolymerization of hydrolyzable and unhydrolyzable litter, and microbial uptake of DOM, turnover, and contribution to litter pools. Both aboveground and belowground plant litter is divided into three pools based on its physicochemical structure. The water-soluble pool is determined as the hot-water extractable fraction of the initial litter, which is continuously replenished during litter decomposition by the depolymerization of the structural litter components, and is contributed by the water-soluble components of microbial biomass turnover, as described further herein. The litter structural component is separated into a hydrolyzable pool, representing polymers, such as proteins and celluloses, and an unhydrolyzable pool representing lignin, suberin, cutin, and microbial polysaccharide-lignin complexes. These litter fractions are commonly measured in decomposing litter or forage analyses. Both structural litter components in the litter layer and rhizosphere produce DOM through their depolymerization and are contributed by structural microbial components as microbes turn over in the litter layer 120 and rhizosphere 130, respectively, as illustrated in FIG. 1.

Similarly to MEMS 1.0, the depolymerization and decomposition processes follow a first-order decay with rate modifiers as multipliers, as shown in Equation (1):

−dCᵢ/dt=k*mᵢ( )*Cᵢ (1)

where Cᵢ is a carbon pool in the i-th layer, k is the decay rate, and mᵢ( ) is a function of the multiplication of the individual modifiers for the i-th layer. For the aboveground soluble and hydrolyzable pools, the modifiers are normalized functions of temperature, moisture, lignocellulose index (LCI), defined as the ratio between acid-insoluble and acid-soluble+acid-insoluble, and microbial C:N ratio (e.g., as in FIGS. 3A-3C). The unhydrolyzable pool does not include the LCI modifier. The belowground soluble pool contributes together with the root exudate to the rhizosphere DOM which decomposes as described above for the aboveground soluble litter pool.

Both the litter layer 120 and the rhizosphere 130 have a microbial biomass pool. Microbes assimilate C from the plant soluble and DOM pools in the litter layer 120 and the rhizosphere 130, respectively. Microbial assimilation of C uses the concept of CUE which is calculated dynamically as a function of substrate C:N ratio, as shown in Equation (2).

CUE=micCNₘₐₓ/(CN_{substrate}+CN_{CUE_km}) (2)

where micCNₘₐₓ is the maximum C:N ratio of microbes, CN_{substrate} is the substrate C:N ratio, and CN_{CUE_km} is a curve adjusting parameter. The substrate C:N ratio calculation includes the organic N in the pool as well as the available mineral N. Any C taken up by microbes from the soluble and DOM pool that is not assimilated (based on CUE) is respired as CO₂. If the N from the substrate is more than the potential N demand of microbes, net mineralization occurs. Otherwise, there is immobilization that consumes mineral N. The C:N ratio of microbes is dynamic as a result of CUE and the N availability from organic and mineral sources. Microbial death also follows a first order equation and the necromass splits between soluble, hydrolyzable, and unhydrolyzable litter pools. The litter decomposition model was created first as a stand-alone model and is incorporated into MEMS 2.0.

Regarding bulk SOM dynamics, the MEMS 2.0 model has five organic matter pools in the bulk soil 140. The POM is defined as the particulate fraction of SOM and can be measured either by density as <1.85-1.6 g cm⁻³, or by size as >50-60 μm after aggregate dispersion. Inputs to the POM pool are from the fragmentation and incorporation of the structural plant and microbial litter components into the bulk soil, from the aboveground litter layer for the topsoil layer, and the rhizosphere for all soil layers. Bioturbation (soil mixing) is simulated as POM moves downward in the soil profile using an equation with the same form as the diffusion equation (Equation S12 in FIG. 3B).

The bulk soil DOM pool receives inputs from the aboveground litter soluble pool (for the top layer only), from the rhizosphere DOM, from depolymerization of POM and from desorption of MAOM. In subsurface soil layers, DOM can also leach from layers above as an input to the bulk soil DOM pool. In the rhizosphere, a greater fraction of the DOM pool is taken up by microbes (in vivo pathway) versus being exported to bulk soil DOM without microbial processing (DOM transport from rhizosphere to bulk soil is simulated as a diffusion process controlled by soil water content and a diffusion coefficient; Equation S9 in FIG. 3A). In the bulk soil, a greater proportion of the DOM pool can directly enter the MAOM pool via the ex vivo pathway, in accordance with the known point-of-entry hypothesis.

The MAOM pool is modelled as two pools: exchangeable MAOM (eMAOM) and stable MAOM (sMAOM). Both eMAOM and sMAOM have an upper limit of saturation that is calculated based on soil clay and silt content. Inputs to eMAOM are from DOM, assuming it can adsorb to mineral surfaces or existing organo-mineral associations with weak bonding that is reversible. This process is modelled using the Langmuir isotherm that assumes instantaneous equilibrium between adsorption and desorption. The DOM can also associate with mineral surfaces through strong bonding, forming sMAOM. This adsorption rate is modelled as a function of water-filled pore space (WFPS), sand content, and the saturation level of sMAOM (Equation S15 in FIG. 3B). The sMAOM primarily receives inputs from microbial external polymeric substances, which are thought to be strongly protected by mineral association, but which can be slowly consumed by microbes through direct access (i.e., no DOM intermediary; Equation S15 in FIG. 3B). Bulk soil microbes assimilate DOM, and their turnover contributes to POM, sMAOM, and DOM, with CO₂ as a byproduct based on microbial CUE (Equation S14 in FIG. 3B). The depolymerization of POM, decomposition of MAOM, and decomposition of DOM follow Equation (1).

Soil surface temperature in MEMS 2.0 may be calculated using a known technique of Parton et al. It is a function of air temperature, litter biomass, plant biomass, and snow depth. The soil surface temperature serves as the upper boundary condition for the soil temperature calculation. To calculate soil temperature, any known method may be used to numerically solve the heat transport equation.

Water and solute transport are calculated simultaneously using any known model. Any known method is used to describe the soil hydraulic properties. If the soil hydraulic parameters are not provided by the user, the MEMS 2.0 model estimates the parameters based on soil texture, bulk density, and SOM content using a pedo-transfer method. The litter layer is assumed to hold water based on a concept similar to field capacity and residual soil water content (SWC). In MEMS 2.0, solutes simulated are DOM, ammonium, and nitrate. Mineral N can be uptaken by plant root and microbes. The competition between plants and microbes is modelled based on their demand (the amount N required to reach maximum N content) using an hourly time step and assuming equal opportunity at each time step.

In an implementation, MEMS 2.0 calculates potential evapotranspiration (ET) using calculated reference ET from a grass reference surface, combined with a dynamic crop coefficient for specific plant types. The reference ET is estimated with the known Hargreaves method that uses daily maximum and minimum temperature data as inputs. The calculation of potential evaporation and transpiration use any known method and in some implementations uses estimated canopy cover from leaf area index (LAI) and crop coefficients. Actual evaporation and transpiration are outputs of the soil water submodel as described further herein.

Regarding plant growth, the plant growth submodel is modified from the known Light INTerception and UtilLisation Version 5 (LINTUL5) crop model and works on a daily time step. In the MEMS 2.0 plant growth submodel, both annual and perennial herbaceous plants can be simulated. Dry matter accumulation or net primary production (NPP) is simulated using radiation use efficiency (RUE). The model can also directly use daily NPP as an input driving variable. Estimation of plant respiration uses any known method.

Aboveground plant components include leaves, stems, and seeds. Belowground components are coarse roots, fine roots, and exudates. Partitioning between roots and shoots is based on species or crop variety-specific parameters defining dry matter allocation from emergence to maturity. The partitioning of aboveground dry matter to leaves, stems, and seeds may use any known method. Crop phenology is calculated based on heat accumulation and photoperiod. Root distribution is modelled using the simple curve from MEMS 1.0. Rooting depth increases from plant emergence to the end of the plant growth phase as a function of phenological development. Root exudation is a species or variety-specific fixed fraction of C allocated belowground. A list of the parameters is illustrated in FIGS. 5A-5C.

Fire has a significant impact on C and N cycling in grasslands, and a fire module is included in MEMS 2.0. In some implementations, fire may use a more detailed representation, including the production of pyrogenic organic matter (PyOM) and its cycling in soil. In MEMS 2.0, natural and prescribed fire events can be scheduled in the management schedule input file of the model. A fire event removes aboveground live and dead biomass and surface litter, according to user-defined percentages of each pool (default values of 60%, 80%, and 80% removal for aboveground live biomass, standing dead, and litter, respectively). Pyrogenic C is returned to the soil surface and added to the unhydrolyzable pool of the aboveground litter layer. A user-defined fraction of the N in burned plant biomass can be also returned to soil surface.

For the MEMS 2.0 model, the most sensitive parameters are the decay rates of the POM and MAOM pools and the temperature effect on decomposition. The role of temperature in controlling decomposition is much higher than the other abiotic factors. For example, a sensitivity analysis showed the parameters of the maximum depolymerization rate of POM and maximum decay rate of stable MAOM were among the most sensitive. The calibrated values for these two parameters were 0.0033 and 0.00034, respectively, which indicated the average turn over time for MAOM was an order of magnitude slower than POM.

Parameters related to soil temperature and moisture effects on decomposition were also relatively sensitive. A temperature effect curve [which served as a modifier in Equation (1)] is used similar in shape to that in MEMS 1.0, but a different equation is used with fewer parameters (Equation S24 in FIG. 3C).

MEMS 2.0 includes two pools of MAOM, characterized as “exchangeable” and “stable”, with the underlying assumption that a certain fraction of the MAOM pool is associated with the mineral surface with week boding and thus exchangeable. A parameter (Frac_MAOMExchangeable) is used to define this fraction (eMAOM) when both eMAOM and sMAOM are saturated. The value of this parameter was selected in the Bayesian optimization with a wide prior range because there is currently little data on which to base this partitioning. When the pools are not saturated, eMAOM is dynamic and it ranged between 14% and 27% in the topsoil layers of the NEON sites in simulations.

In an implementation, microbiota is modelled as a single entity in each model compartment, despite the significant differences between microbial groups in growth forms, life strategies, biomass stoichiometry, substrate preferences, and many traits that influence C and N cycling. The complexity of the microbial aspects of the model may be increased in future model versions, beginning with separation of bacteria and fungi, which will include representing arbuscular and ectomycorrhizal systems separately because of their highly contrasting traits. In future model implementations, bacterial and fungal pools will have different N demands, CUEs, growth rates, substrate preferences, pH preferences, responses to disturbance, and necromass contributions to plant litter and SOM pools.

Soil pH is a static soil property in MEMS 2.0, but pH is dynamic in nature and has important effects on plant growth, microbial activity, and SOM dynamics. Representing sites where shifts in pH may be a major driver of C and N dynamics (e.g., fertilized systems) will benefit from dynamic modelling of pH and its effect on decomposition.

Thus, MEMS 2.0 is an ecosystem model built on foundational principles including: 1) the use of measurable pools that can be directly validated, 2) the MEMS hypothesis linking litter chemistry to microbial carbon use efficiency and SOM formation, and 3) saturation behavior of the MAOM pool. In developing MEMS 2.0, a full ecosystem model has been created and expanded upon the foundational principles to incorporate updated understanding of SOM dynamics such as the use of two distinct pathways for POM and MAOM formation, the point-of entry framework, and in vivo and ex vivo pathways of MAOM formation, through the entire soil profile. Future development may incorporate additional controls on SOM dynamics such as management impacts and additional environmental factors including variable pH and redox conditions, mineralogy, soil microbial community structure, and temperature sensitivities.

The MEMS 2.0 ecosystem model provides an understanding of plant-microbial-soil C and N dynamics, using biophysically defined and measurable pools and fluxes. The model can be improved over time to represent different ecosystems and drivers (e.g., fire, fauna, and management) as new understanding emerges. MEMS 2.0 generally captures total soil organic C stocks and their distributions between POM and MAOM throughout the soil profile.

FIG. 7 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 7, an exemplary system for implementing aspects described herein includes a computing device, such as computing device 700. In its most basic configuration, computing device 700 typically includes at least one processing unit 702 and memory 704. Depending on the exact configuration and type of computing device, memory 704 may be volatile (such as random access memory (RAM)), non-volatile (such as read-only memory (ROM), flash memory, etc.), or some combination of the two. This most basic configuration is illustrated in FIG. 7 by dashed line 706.

Computing device 700 may have additional features/functionality. For example, computing device 700 may include additional storage (removable and/or non-removable) including, but not limited to, magnetic or optical disks or tape. Such additional storage is illustrated in FIG. 7 by removable storage 708 and non-removable storage 710.

Computing device 700 typically includes a variety of computer readable media. Computer readable media can be any available media that can be accessed by the device 700 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 704, removable storage 708, and non-removable storage 710 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer storage media may be part of computing device 700.

Computing device 700 may contain communication connection(s) 712 that allow the device to communicate with other devices. Computing device 700 may also have input device(s) 714 such as a keyboard, mouse, pen, voice input device, touch input device, etc. Output device(s) 716 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

In an implementation, a system comprises: a plurality of inputs; and a microbial efficiency-matrix stabilization (MEMS) 2.0 ecosystem model configured to receive the plurality of inputs and generate information around the pools and fluxes of C and N in the soil, plant and the atmosphere; and a plurality of outputs comprising the generated information.

Implementations may include some or all of the following features. The inputs comprise input files, parameter data, an operation schedule, net primary productivity (NPP) data, and weather data. The input files comprise a control file, a site file, and a weather file. The parameter data comprises base parameters, plant parameters, and site parameters. The ecosystem model is configured to create a one-dimension soil profile and divide the one-dimension soil profile into continuous soil horizons in a model input file, with user-defined depths for each horizon. The ecosystem model is configured to, while executing a model simulation, divide the soil horizons into thinner layers to solve partial differential equations. The ecosystem model is configured to run simulations in accordance with submodels. The submodels comprise algorithms respectively directed to an atmosphere submodel, a plant submodel, a soil surface submodel, and a soil submodel. The atmosphere submodel comprises weather, evapotranspiration (ET) demand, and N deposition. The plant submodel comprises aboveground biomass, belowground biomass, and exudate. The soil surface submodel comprises litter and surface temperature. The soil submodel comprises soil layer, soil water, soil temperature, soil minerals, nitrate, ammonium, and soil organic matter (SOM) pools. The outputs are produced on a daily time step or a sub-daily time step. The system further comprises a storage device to store the outputs in output files.

In an implementation, a method comprises: receiving a plurality of inputs at a microbial efficiency-matrix stabilization (MEMS) 2.0 ecosystem model, wherein the inputs comprise weather, soil properties, plant characteristics, and management practices; creating a soil profile and dividing the soil profile into continuous soil horizons in a model input file, with user-defined depths for each horizon; running a plurality of simulations with submodels using the MEMS 2.0 ecosystem model with the inputs and divided soil profile; producing outputs from the simulations with submodels, on a daily time step or a sub-daily time step; and providing the outputs to a display device or a storage device.

Implementations may include some or all of the following features. The submodels comprise algorithms respectively directed to an atmosphere submodel, a plant submodel, a soil surface submodel, and a soil submodel, wherein the atmosphere submodel comprises weather, evapotranspiration (ET) demand, and N deposition, wherein the plant submodel comprises aboveground biomass, belowground biomass, and exudate, wherein the soil surface submodel comprises litter and surface temperature, and wherein the soil submodel comprises soil layer, soil water, soil temperature, soil minerals, nitrate, ammonium, and soil organic matter (SOM) pools. The method further comprises while executing a model simulation, dividing the soil horizons into thinner layers to solve partial differential equations.

In an implementation, a one-dimension ecosystem model includes nitrogen (N) cycling, soil vertical water flows, dissolved organic matter (DOM) transport, plant growth, root input, and soil temperature dynamics, and wherein the ecosystem model represents distinct plant inputs and microbial processes in the litter layer and rhizosphere, and DOM, particulate organic matter (POM) and mineral-associated organic matter (MAOM) dynamics in the bulk soil to a user-defined depth above the bedrock.

Implementations may include some or all of the following features. The ecosystem model uses data from plants to simulate litter layer, rhizosphere, and bulk soil C, N, water, and temperature, and plant growth. The litter layer simulates information including soluble litter, hydrolyzable litter, unhydrolyzable litter, and litter layer microbes, and CO2, water flow, and mineral N, and the rhizosphere simulates information including exudation, rhizosphere DOM, CO2, mineral N, rhizosphere microbes, soluble root litter, hydrolyzable root litter, and unhydrolyzable root litter, in various soil layers, and the bulk soil simulates fragmentation, depolymerization, POM, DOM, CO2, mineral N, bulk soil microbes, exchangeable and stable component pools (eMAOM and sMAOM, respectively), and leaching, in various soil layers.

As used herein, the singular form “a,” “an,” and “the” include plural references unless the context clearly dictates otherwise. As used herein, the terms “can,” “may,” “optionally,” “can optionally,” and “may optionally” are used interchangeably and are meant to include cases in which the condition occurs as well as cases in which the condition does not occur.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A system comprising:
a plurality of inputs; and
a microbial efficiency-matrix stabilization (MEMS) 2.0 ecosystem model configured to receive the plurality of inputs and generate information around the pools and fluxes of C and N in the soil, plant and the atmosphere; and a plurality of outputs comprising the generated information.

2. The system of claim 1, wherein the inputs comprise input files, parameter data, an operation schedule, net primary productivity (NPP) data, and weather data.

3. The system of claim 2, wherein the input files comprise a control file, a site file, and a weather file.

4. The system of claim 2, wherein the parameter data comprises base parameters, plant parameters, and site parameters.

5. The system of claim 1, wherein the ecosystem model is configured to create a one-dimension soil profile and divide the one-dimension soil profile into continuous soil horizons in a model input file, with user-defined depths for each horizon.

6. The system of claim 5, wherein the ecosystem model is configured to, while executing a model simulation, divide the soil horizons into thinner layers to solve partial differential equations.

7. The system of claim 1, wherein the ecosystem model is configured to run simulations in accordance with submodels.

8. The system of claim 7, wherein the submodels comprise algorithms respectively directed to an atmosphere submodel, a plant submodel, a soil surface submodel, and a soil submodel.

9. The system of claim 8, wherein the atmosphere submodel comprises weather, evapotranspiration (ET) demand, and N deposition.

10. The system of claim 8, wherein the plant submodel comprises aboveground biomass, belowground biomass, and exudate.

11. The system of claim 8, wherein the soil surface submodel comprises litter and surface temperature.

12. The system of claim 8, wherein the soil submodel comprises soil layer, soil water, soil temperature, soil minerals, nitrate, ammonium, and soil organic matter (SOM) pools.

13. The system of claim 1, wherein the outputs are produced on a daily time step or a sub-daily time step.

14. The system of claim 1, further comprising a storage device to store the outputs in output files.

15. A method comprising:
receiving a plurality of inputs at a microbial efficiency-matrix stabilization (MEMS) 2.0 ecosystem model, wherein the inputs comprise weather, soil properties, plant characteristics, and management practices;
creating a soil profile and dividing the soil profile into continuous soil horizons in a model input file, with user-defined depths for each horizon;
running a plurality of simulations with submodels using the MEMS 2.0 ecosystem model with the inputs and divided soil profile;
producing outputs from the simulations with submodels, on a daily time step or a sub-daily time step; and
providing the outputs to a display device or a storage device.

16. The method of claim 15, wherein the submodels comprise algorithms respectively directed to an atmosphere submodel, a plant submodel, a soil surface submodel, and a soil submodel, wherein the atmosphere submodel comprises weather, evapotranspiration (ET) demand, and N deposition, wherein the plant submodel comprises aboveground biomass, belowground biomass, and exudate, wherein the soil surface submodel comprises litter and surface temperature, and wherein the soil submodel comprises soil layer, soil water, soil temperature, soil minerals, nitrate, ammonium, and soil organic matter (SOM) pools.

17. The method of claim 15, further comprising while executing a model simulation, dividing the soil horizons into thinner layers to solve partial differential equations.

18. A one-dimension ecosystem model, wherein the ecosystem model includes nitrogen (N) cycling, soil vertical water flows, dissolved organic matter (DOM) transport, plant growth, root input, and soil temperature dynamics, and wherein the ecosystem model represents distinct plant inputs and microbial processes in the litter layer and rhizosphere, and DOM, particulate organic matter (POM) and mineral-associated organic matter (MAOM) dynamics in the bulk soil to a user-defined depth above the bedrock.

19. The ecosystem model of claim 18, wherein the ecosystem model uses data from plants to simulate litter layer, rhizosphere, and bulk soil C, N, water, and temperature, and plant growth.

20. The ecosystem model of claim 19, wherein the litter layer simulates information including soluble litter, hydrolyzable litter, unhydrolyzable litter, and litter layer microbes, and CO₂, water flow, and mineral N, and the rhizosphere simulates information including exudation, rhizosphere DOM, CO₂, mineral N, rhizosphere microbes, soluble root litter, hydrolyzable root litter, and unhydrolyzable root litter, in various soil layers, and the bulk soil simulates fragmentation, depolymerization, POM, DOM, CO₂, mineral N, bulk soil microbes, exchangeable and stable component pools (eMAOM and sMAOM, respectively), and leaching, in various soil layers.
